(19) United States
(12) Patent Application Publication
(10) Pub. No.: US 2005/0097039 A1
(43) Pub. Date: May 5, 2005

(54) Multiple credit card management system

(76) Inventors: Laszlo Kulcsar, Brookfield, WI (US); Gwenda Kulcsar, Brookfield, WI (US)

Correspondence Address: LISA A. BRZYCKI;Gehrke & Associates, S.C., 123 North 86th Street, Wauwatosa, WI, 53226, US

(21) Appl. No.: 10/702,144

(22) Filed: Nov. 5, 2003

(51) Int. Cl. G06F 17/60

(52) U.S. Cl. 705/40; 705/35

(57) ABSTRACT

According to one aspect of the invention, a method for coordinating the management of credit between an Internet user and a plurality of lending institutions via the Internet, includes the steps of receiving account information on at least one credit account from the plurality of lending institutions or the Internet user, storing the account information in a database, receiving selection criteria from the Internet user specifying conditions under which each of the at least one credit account is authorized to be used, receiving from a merchant a request for authorization of a transaction, processing the request including selecting one of the at least one credit account to be used for the transaction, transmitting the account information corresponding to the selected account to the lending institution associated with the selected account, receiving an authorization status from the lending institution, selecting a different account to request authorization from the lending institution associated with the selected account if the authorization status is a denial, and transmitting the authorization status to the merchant.

### BACKGROUND OF THE INVENTION

1. Field of the Invention

The present invention relates generally to a universal card to manage multiple accounts. In particular, the present invention relates to a credit/debit card that allows a person to make a credit purchase using a single universal credit card that is associated with pre-established credit accounts. The amount of the purchase is charged to one or more of the pre-established credit accounts based on predetermined criteria chosen by the user.

2. Discussion of the Related Art

When making a credit card purchase, a person typically selects a MasterCard™ or Visa™ card to enable the person to make a purchase or acquire a cash advance according to a particular card's credit/cash advance limit. The standard cards also include substantial annual fees, late payment charges and overdraft fees. In fact, the majority of the accounts will allow a person to incur an overdraft in order to avoid personal embarrassment. In this case, the fees incurred from the overdraft may even be larger than the actual purchase itself.

The credit industry is a multibillion dollar market where over 80% of revenue is directly attributable to “miscellaneous fees” including late/overdraft fees as opposed to interest revenue on the borrowed money. Therefore, it is obviously in the credit industry's best interest not to create systems that allow card holders to avoid these “miscellaneous fees” by properly managing their accounts while optimizing their payments so that the lowest interest card is always the primary card that is paid off first.

In the current credit environment, a person also typically has several credit cards from the same institutions. The majority of card issuers from these institutions allow a person to access account information via the Internet where the person may make payments, view statements and edit personal information. The person directs their browser to the particular site and enters a password for each individual card even if they have several cards with the same institution. In some cases, a person also has to enter multiple login names at the same site as well as multiple passwords associated with each login name.

The use of several different cards when making a purchase also increases the risk of fraud. It is relatively easy for a person to make a credit purchase using a stolen card. Few merchants actually refuse the purchase if the signature on the back of the card does not appear to match the person's signature on the credit slip.

What is needed, therefore, to overcome these inherent limitations of making a credit purchase based on multiple credit cards is a single universal credit card that enables a person to make a purchase based on a predefined criteria as applied to several preestablished credit accounts associated with the universal card.

### SUMMARY OF THE INVENTION

According to one aspect of the invention, a method for coordinating the management of credit between an Internet user and a plurality of lending institutions via the Internet, includes the steps of receiving account information on at least one credit account from the plurality of lending institutions or the Internet user, storing the account information in a database, receiving selection criteria from the Internet user specifying conditions under which each of the at least one credit account is authorized to be used, receiving from a merchant a request for authorization of a transaction, processing the request including selecting one of the at least one credit account to be used for the transaction, transmitting the account information corresponding to the selected account to the lending institution associated with the selected account, receiving an authorization status from the lending institution, selecting a different account to request authorization from the lending institution associated with the selected account if the authorization status is a denial, and transmitting the authorization status to the merchant.

According to another aspect of the invention, a network system for coordinating the management of credit between an Internet user and a plurality of lending institutions via the Internet includes a database for storing and receiving account information, means for receiving account information on at least one credit account from the plurality of lending institutions or the Internet user, means for storing the account information in a database, means for receiving selection criteria from the Internet user specifying conditions under which each of the at least one credit account is authorized to be used, means for receiving from a merchant a request for authorization of a transaction, means for processing the request including selecting one of the at least one credit account to be used for the transaction, means for transmitting the account information corresponding to the selected account to the lending institution associated with the selected account, means for receiving an authorization status from the lending institution, means for selecting a different account to request authorization from the lending institution associated with the selected account if the authorization status is a denial, and means for transmitting the authorization status to the merchant.

According to yet another aspect of the invention, a network system for coordinating the management of credit between an Internet user and a plurality of lending institutions via the Internet includes a database for storing and receiving account information, a magstripe writing device configured to write data to a magstripe on a card corresponding to a particular account, means for receiving account information on at least one credit account from the plurality of lending institutions or the Internet user, means for storing the account information in a database, and means for receiving selection criteria from the Internet user specifying which credit account information is to be written by the magstripe writing device on the card.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A clear understanding of the various advantages and features of the present invention, as well as the construction and operation of conventional components and mechanisms associated with the present invention, will become more readily apparent by referring to the exemplary, and therefore non-limiting, embodiments illustrated in the following drawings which accompany and form a part of this patent specification.

FIG. 1 is an illustration of the multiple credit card management system according to the preferred embodiment of the present invention;

FIG. 2 is an illustration of a front side of a universal card according to the preferred embodiment of the present invention;

FIG. 3 is an illustration of a back side of a universal card according to the preferred embodiment of the present invention;

FIG. 4 is an illustration of a multiple credit card management system gateway and interface according to the preferred embodiment of the present invention;

FIG. 5 is an illustration of the database associated with the multiple credit card management system according to the preferred embodiment of the present invention;

FIG. 6 is an illustration of the activation of the system according to the preferred embodiment of the present invention;

FIG. 7 is an illustration of personal security of a universal card according to the preferred embodiment of the present invention;

FIG. 8 is an illustration of transaction choices in a multiple credit card management system according to the preferred embodiment of the present invention;

FIG. 9 is an illustration of a customer service center of a universal card according to the preferred embodiment of the present invention;

FIG. 10 is an illustration of a contact transaction according to the preferred embodiment of the present invention;

FIG. 11 is an illustration of a frequently asked questions transaction according to the preferred embodiment of the present invention; and

FIG. 12 is an illustration of the accounts in the multiple credit card management system according to the preferred embodiment of the present invention.

### DETAILED DESCRIPTION OF THE PREFERRED EMBODIMENTS

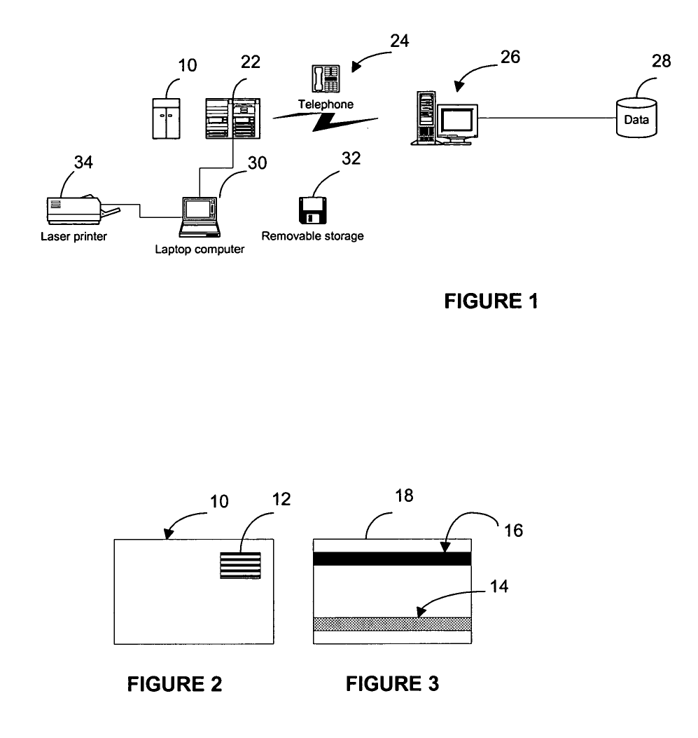

Referring to FIGS. 1-3, a universal card 10 allows a person to make a purchase based on predefined criteria. Card 10 includes a memory 12 that is able to store data. Memory 12, however, is not required for card 10 to be used. In particular, card 10 also includes a credit strip 14 and a telephone strip 16. Strips 14 and 16 are placed on card 10 a particular distance from a top edge 18 and a bottom edge 20 to enable card 10 to be inserted by the merchant in a standard card reader so that either strip is easily read.

In one embodiment of the present invention, card 10 is inserted in a stand-alone PDA-type device 22. Device 22 includes a bar code writer that rewrites strips 14 and/or 16 based on accounts that are chosen by the user. In this regard, reader 22 interfaces via a communication line 24 with a web-based multiple credit management system 26.

Management system 26 includes a large-scale database 28 that stores comprehensive data relating to every credit account associated with each user of system 26.

Communication line 26 may be a telephone modem, a high speed internet cable, a wireless system, or any other communication link that is well-known by one skilled in the art.

In an alternative embodiment of the present invention, device 22 is integrated into a personal computer 30 and data from database 28 is stored on a removable storage medium 32 to eliminate the necessity of communicating with management system 26 over communication line 26. This is useful in the event management system 26 is temporarily inoperable or a communication line is unavailable, yet a user needs to rewrite strips 14 or 16 with different account information.

Assuming computer 30 is linked with a printer 34, a user may easily print out a history of all credit transactions stored in memory 12 for a particular day, week, month, etc. This transaction information can also be automatically uploaded into database 28 via communication line 24.

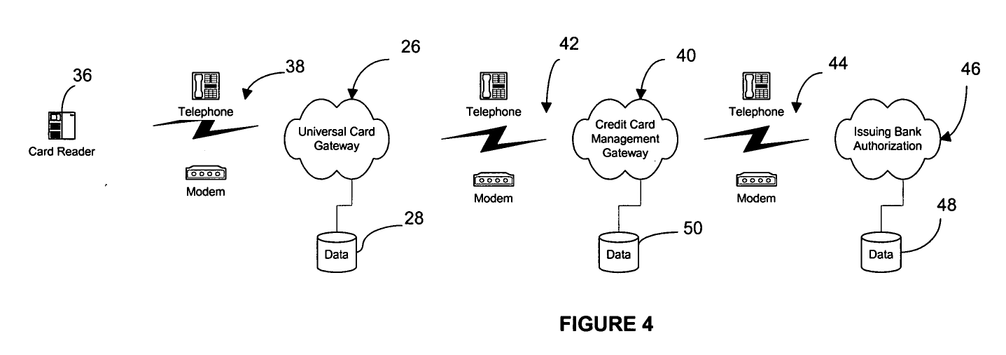

As illustrated in FIG. 4, after card 10 is inserted into a card reader 36 and swiped by a merchant, information is transmitted via a dataline 38 to management system 26 that serves as a universal card gateway for transactions. Database 28 associated with management system 26 includes all relevant data necessary to complete a purchase including specific credit account numbers, account limits, interest rates, minimum payment data, etc.

The particular account that is chosen by database 28 for a transaction is determined by a person prior to the purchase. For example, the person may decide to charge all purchases to the account with the lowest interest rate that has the funds available for the particular purchase.

Based on the predefined criteria, universal card gateway 26 queries an authorizing entity 40 via a dataline 42 to determine whether a successful transaction can be completed. Authorizing entity 40 is a credit card gateway that routes the transaction request via dataline 44 to the appropriate bank 46 that issued the particular account.

Bank 46 responds to the transaction request by issuing a query to its associated database 48, and then transmitting the results of the transaction request back to credit card gateway 40 via line 44. Credit card gateway 40 determines which bank to route the transmission request to based on its associated database 50.

The result of the transaction request is transmitted back to the merchant via line 38 by management system 26 as either the transaction is authorized or declined. Various codes associated with the status of the transaction are also transmitted via line 38 as further explanation of the transaction (e.g., if approved, an approval code is transmitted; if declined, a reason for the disapproval of the request is transmitted - insufficient funds, over the limit, expired card, etc.).

If management system 26 does not received authorization for an approved transaction via line 42 from gateway 40, system 26 may issue another transaction request based on an alternative account. In this regard, system 26 iterates through all of the available accounts based on the user predefined criteria to attempt to successfully complete the transaction. This process of issuing several queries to gateway 40 is transparent to the merchant and, if possible, a “decline” code is not sent to reader 36 unless and until all of the credit account possibilities are exhausted.

In operation, when a merchant scans card 10, system 26 interfaces with credit card gateway 40 to authenticate whether the user is enrolled in the “verified by Visa” or “MasterCard SecureCode” or other appropriate card associations. The authentication request is forwarded via line 44 to the appropriate issuing bank 46 for approval of the transaction. The status of approval is then transmitted back by bank 46 to gateway 40 and then the merchant via management system 26.

Magstripe 14 or 16 on the back of card 10 can be “written” because the tiny bar magnets are magnetized in either a north or south pole direction. Strips 14 or 16 are similar to a cassette tape. The magnets are iron-based magnetic particles in a plastic-like film. Each particle is really a very tiny bar magnet about 20 millionths of an inch long.

There are three tracks on each magstripe 14 or 16, and each of the tracks are approximately 0.110 inch wide. The ISO/IEC standard 7811 used by banks specifies:

1. Track one is 210 bits per inch (bpi) and holds 79 six-bit plus parity bit read-only characters;

2. Track two is 75 bpi and holds 40 four-bit plus parity bit characters; and

3. Track three is 210 bpi and holds 107 four-bit plus parity bit characters.

Card 10 uses the first two tracks while the third track is a read/write track that includes an encrypted PIN, country code, currency units and authorized amounts. The usage of the third track is not standardized among banks.

As explained above, there are two ways a user may use card 10. In the first manner, strips 14 and/or 16 include account information that is rewritten using a bar code writer device 22. In the preferred embodiment of the present invention, however, device 22 is not necessary because strips 14 and/or 16 are only written once so that when a merchant swipes card 10, management system 26 is contacted and system 26 then determines which account to use. In the alternative case, strips 14 and/or 16 are continually rewritten with account information so that when a merchant swipes card 10, credit card management gateway 40 is directly contacted without first interfacing with management system 26.

Strip 16 contains telephone minute account information that may be similarly updated by interfacing with database 28 via gateway 26.

In addition to using card 10 to make internet purchases or purchases from various merchants, card 10 can also be used to increase the speed of transactions at fast food restaurants. In particular, card 10 is linked to database 28 that includes separate account information corresponding to particular restaurants (McDonalds, Burger King, etc.).

The account information relating to these restaurants may be in the form of credit or may be a prepaid account that can only be used for those particular restaurants. In either case, the user presents card 10 at time of payment for the product. The use of card 10 significantly decreases the transaction time for each order. In this regard, over 75% of transaction time in fast food restaurants is expended in the process of “making change” for customers. Therefore, by decreasing the time spent on this process, the restaurant is able to process substantially more orders which directly translates to increased revenue for the restaurant.

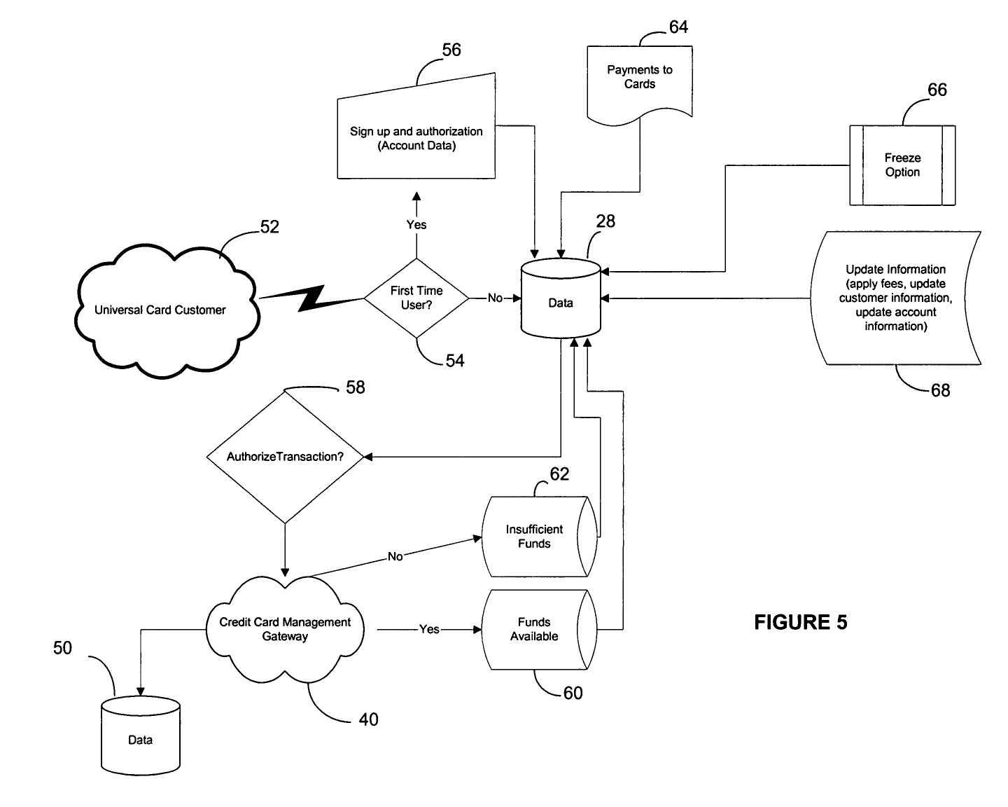

FIG. 5 illustrates the interface between a client 52 and database 28 of management system 26 using a GUI that is available on standard internet browsers as is well-known by those skilled in the art.

Management system 26 allows client 52 to log into database 28 to view account information for all of the accounts in system 26 using a single login and a single password. In the preferred embodiment of the present invention, database 28 is a large transactional database that is well-known by a person skilled in the art (e.g., Oracle™, Microsoft SQL Server™, MySQL™).

At a decision block 54, system 26 determines if client 52 is a first time user. If client 52 is a first time user, then client 52 registers with system 26 for an account in a block 56 by entering into database 28 relevant personal information along with particular information for every account to be managed by system 26. If client 52 is not a first time user, then client 52 chooses among other options.

As illustrated in FIG. 4, based on database 28, system 26 selects a particular account for authorization in a block 58. If the transaction is approved by gateway 40 in a block 60, then the approved decision is transmitted back to database 28, which is then routed to the merchant. If the transaction is not approved by gateway in a block 62, then system 26 iterates through client 52's accounts to requery gateway 40.

In an alternative embodiment of the present invention, gateway 40 is eliminated and system 26 also functions as a bank that directly authorizes transactions without having to query any additional gateways.

Payments to particular client accounts are made via a payment block 64. Client 52 also has the ability to freeze particular accounts via freeze block 66. Finally, information is continually updated in database 28 via an update block 68. In addition to relying on clients 52 to update information, data in database 28 pertaining to account information may also be automatically updated when system 26 interfaces with particular accounts for payment or other transactions.

The information relating to the client accounts includes available balances, interest rate, payment due date, minimum amounts due, account numbers, issuing bank, late fee policies, overlimit fee policies, etc. In the preferred embodiment of the present invention, client 52 pays a percentage of each transaction for the management of the multiple credit accounts with system 26. In the alternative, a monthly fee may be charged for use of management system 26.

As described above, database 28 filters purchases by selecting credit accounts using a particular predefined user criteria. For example, purchases may be applied against a credit account with the lowest interest rate.

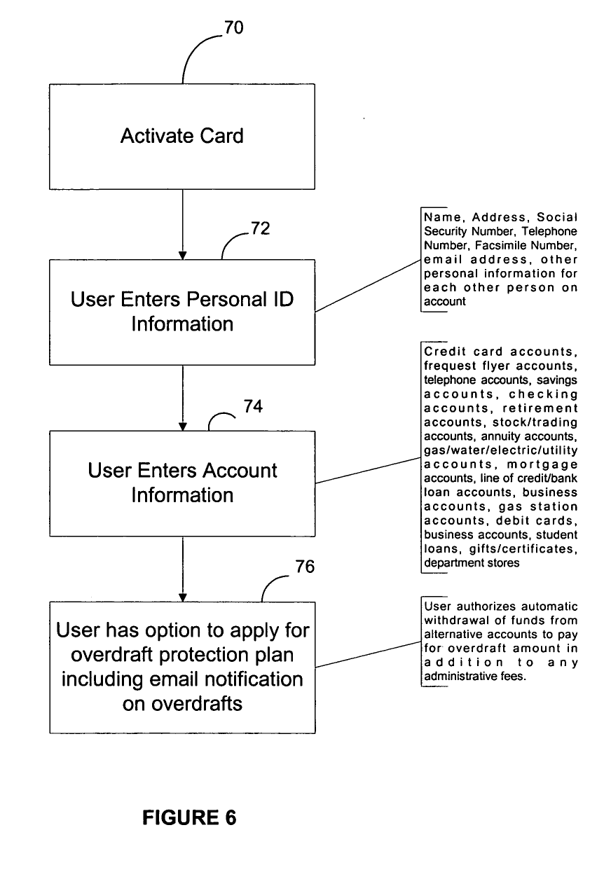

Referring to FIG. 6, client 52 activates card 10 in a block 70. Personal information is entered in a block 72, and specific account data is entered in a block 74. Finally, in a block 76, client 52 has the option to apply for overdraft protection that includes notification via email of overdrafts.

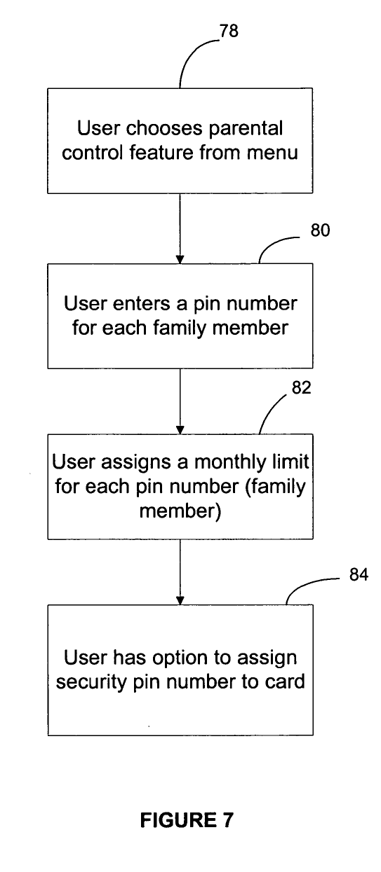

Referring to FIG. 7, client 52 may choose a parental control feature in a block 78. Client 52 enters a pin number for each member of the family that intends on using card 10 in block 80. Client 52 also assigns a monthly limit for each pin number in a block 82. Client 52 may also assign a card pin number to card 10 in a block 84.

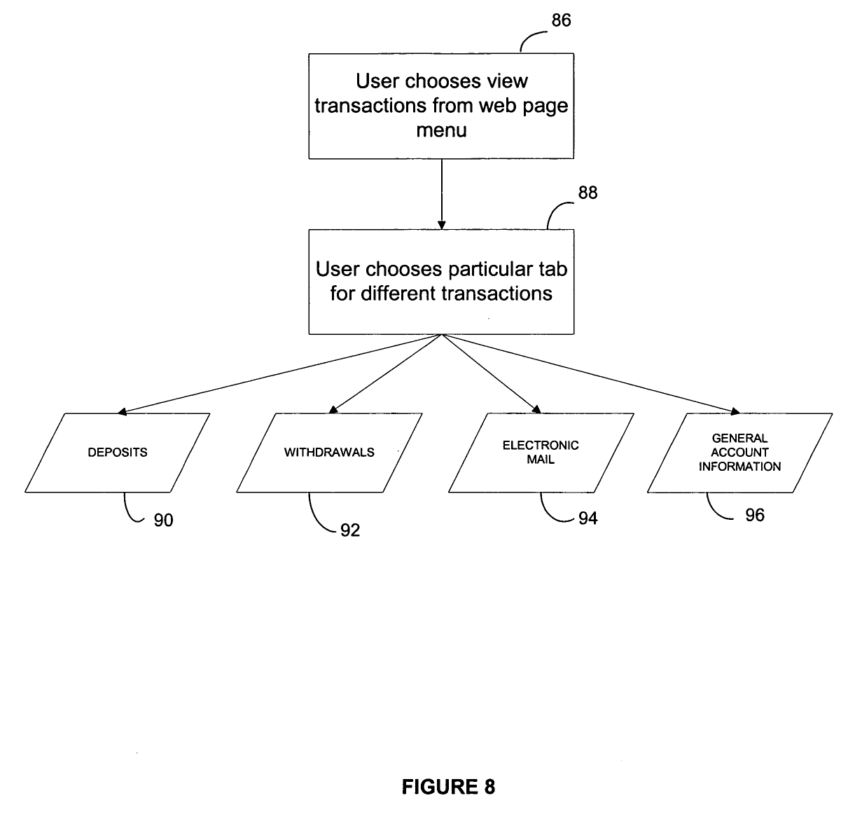

Referring to FIG. 8, client 52 chooses to view transactions from a web page implemented in system 26 via a block 86. A series of different tabs for various transactions are displayed via a block 88. The transactions include a deposit transaction 90, a withdrawal transaction 92, an electronic mail transaction 94, and a general account transaction 96.

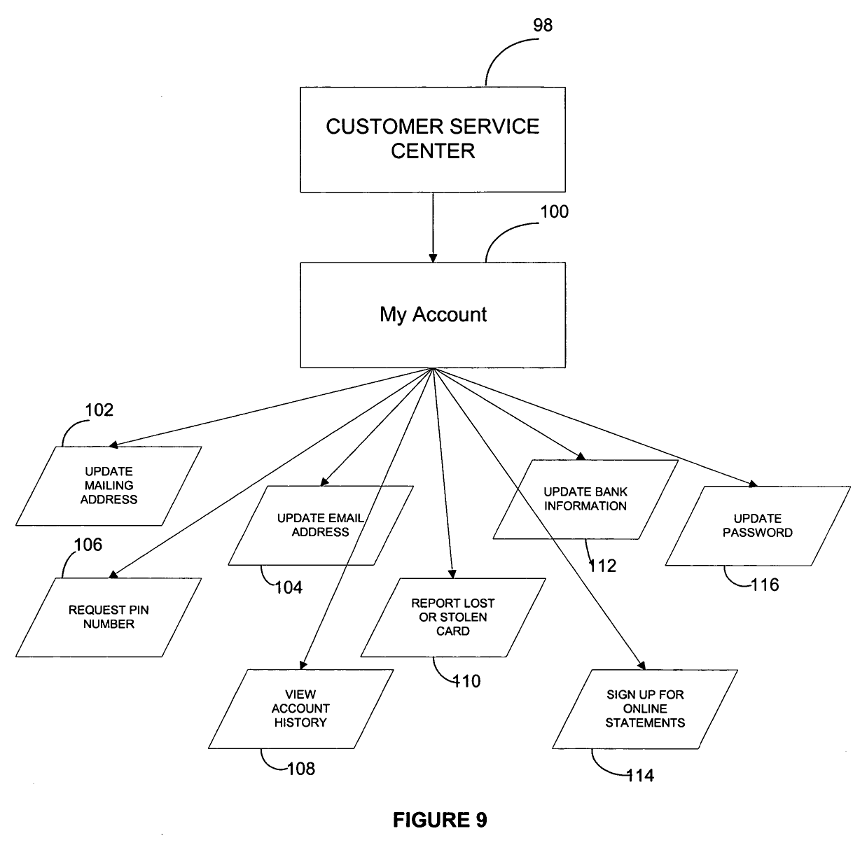

In a Customer Service Center 98 of system 26 in FIG. 9, client 52 views account information via a block 100. Account information includes a block 102 for updating addresses, a block 104 for updating email addresses, a block 106 for requesting PIN information, a block 108 for viewing an account history, a block 110 for reporting lost or stolen cards, a block 112 for updating bank information, a block 114 for signing up for online statements, and a block 116 for updating passwords.

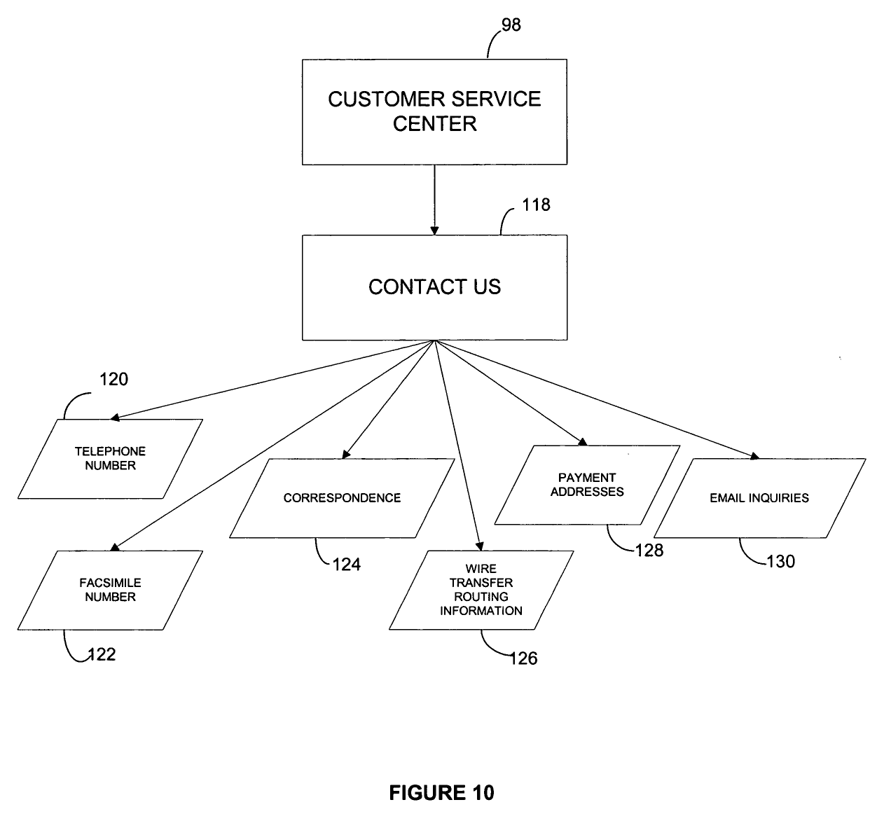

As illustrated in FIG. 10, there is a contact block 118 in Customer Service Center 98 that includes a telephone number 120, a facsimile number 122, a correspondence address 124, a wire transfer routing information block 126, a listing of payment addresses 128 and a listing of email inquiry addresses 130.

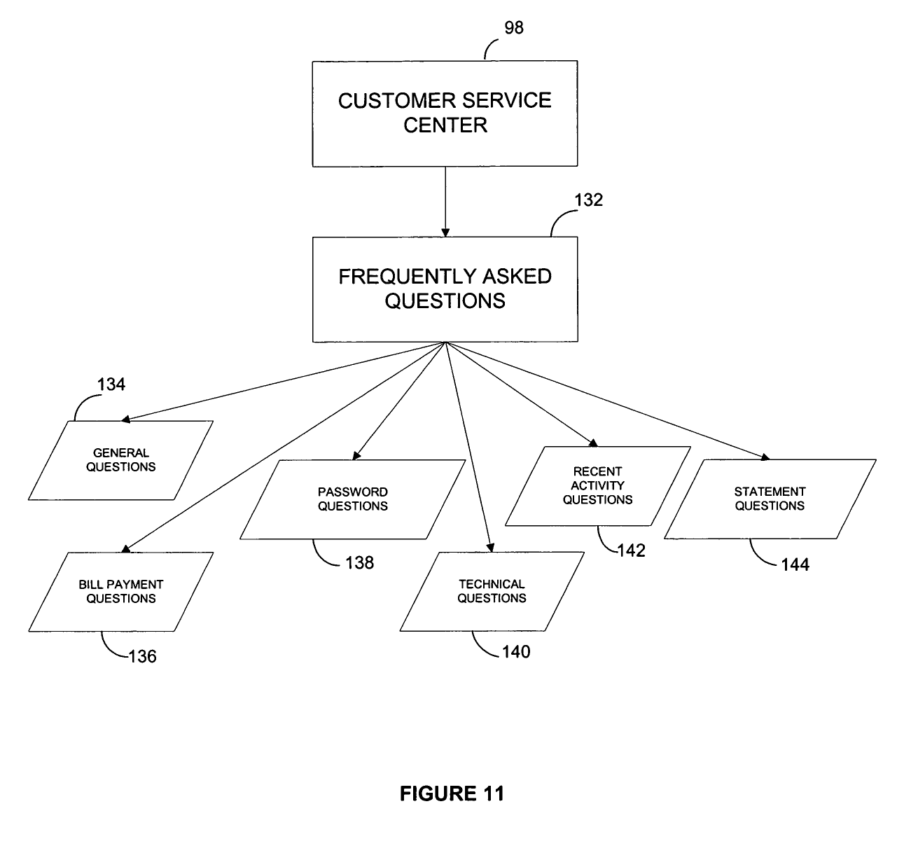

As illustrated in FIG. 11, there is a frequently asked questions block 132 in Customer Service Center 98 that includes a general questions block 134, a bill payment block 136, a password question block 138, a technical question block 140, a recent activity block 142 and a statement block 144.

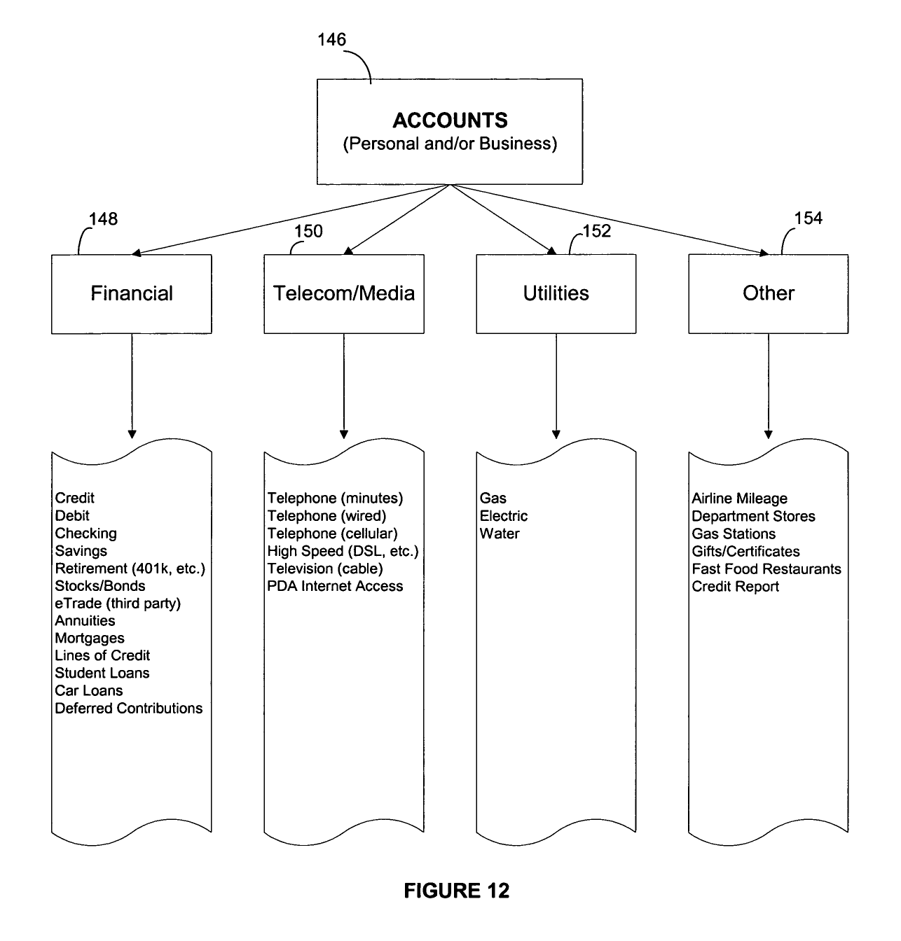

Finally, as illustrated in FIG. 12, there is an accounts block 146 that applies to both personal and/or business accounts. System 26 is designed to accommodate both individual clients and business clients. In this regard, each of the specific accounts are examples and not limited to a particular type of account. Examples of some account types include financial accounts 148, telecommunications/media accounts 150, utility accounts 152 and miscellaneous accounts 154.

Financial accounts 148 include credit, debit, checking, savings, retirement (401 k, etc.), stocks/bonds, third party (eTrade™, etc.), annuities, mortgages, lines of credit, student loans, car loans, deferred contributions, etc.

Telecommunication/media accounts 150 include telephone (minutes, wired, cellular, DSL, ISDN), television (cable), PDA internet access, etc.

Utility accounts 152 include gas, water, electric, etc.

Other miscellaneous accounts 154 include airline mileage, department stores, gas stations, gifts/certificates, fast food restaurants, credit reports, etc.

If a primary account is denied authorization, then an alternative account may be queried based on the predefined criteria established by client 52 via system 26 interfacing with database 28. These parameters associated with database 28 include which credit account to use, not allowing a person to go over the credit limit of a particular credit account, allowing a person to use a different credit account if another credit account does not have enough available credit for the purchase instead of incurring overlimit fees, and splitting a large purchase among several different accounts.

System 26 also searches for the credit account with the lowest interest rate prior to processing the transaction. If the account with the lowest interest rate does not have enough credit available for the purchase, database 28 will identify the next lowest interest rate account for the purchase and query if there is enough credit available to complete the transaction.

As explained above, system 26 may also split the amount of the particular purchase between the multiple credit accounts by using all of the credit available on the lowest interest credit account and applying the remaining amount of the purchase to the next lowest interest rate credit account.

System 26 provides client 52 with the convenience of not having to carry around multiple credit cards and money saving opportunities. In particular, client 52 uses card 10 to access all current credit cards by simply “activating” a membership.

System 26 further alerts clients 52 with due dates of payments for individual credit accounts and may withdraw necessary funds from a savings account, a checking account, or another credit account to automatically cover the payment for a particular credit account. Clients 52 may also choose to implement this automatic payment system only if a payment is not received in time to avoid late fees.

As illustrated in FIG. 7, client 52 also has the option of requesting a pin number that must be entered at the moment a card is presented for a transaction. This pin number must be entered in order for the transaction to be processed, thereby adding an extra measure of security against stolen or lost cards, or against children attempting to use a credit account without parental approval.

Client 52 may also assign a limited amount of money to be used per transaction, thereby limiting and supervising funds being used by children.

Management system 26 allows client 52 to access and manage all credit and other accounts using a single login and associated password, provides clients 52 with monetary savings based on automatically applying transactions to the lowest interest rate credit account, provides overdraft protection thereby reducing the number of overdraft fees, protects against fraudulent activity with the use of separate pin numbers, supervises third-party use (e.g., children) of card 10 with PIN numbers, reduces the number of cards a client has to access in order to complete a transaction and provides credit protection.

The scope of the application is not to be limited by the description of the preferred embodiments described above, but is to be limited solely by the scope of the claims that follow. For example, a bar code writing device may be used to write specific bar codes associated with particular accounts without interfacing with system 26 without departing from the scope of the preferred embodiment of the present invention.

1. A method for coordinating the management of credit between an Internet user and a plurality of lending institutions via the Internet, comprising the steps of:
receiving account information on at least one credit account from the plurality of lending institutions or the Internet user;
storing the account information in a database;
receiving selection criteria from the Internet user specifying conditions under which each of the at least one credit account is authorized to be used;
receiving from a merchant a request for authorization of a transaction;
processing the request including selecting one of the at least one credit account to be used for the transaction;
transmitting the account information corresponding to the selected account to the lending institution associated with the selected account;
receiving an authorization status from the lending institution;
selecting a different account to request authorization from the lending institution associated with the selected account if the authorization status is a denial; and
transmitting the authorization status to the merchant.

2. The method according to claim 1, further comprising the steps of:
transmitting the account information corresponding to the selected account to a credit card management gateway, wherein the gateway routes the authorization request to the lending institution associated with the selected account;
wherein the credit card management gateway receives the authorization status from the lending institution and transmits the authorization status to the database.

3. The method according to claim 1, wherein the step of receiving account information comprises the steps of:
displaying a document welcoming the Internet user;
displaying a document explaining the coordination of the credit management process;
displaying a document explaining the services provided;
requesting the account information including a name of the lending institution, an account number, a credit balance, a payment due date, an interest rate, a billing address, an account limit, a web site corresponding to the account, a password corresponding to the account on the web site associated with the lending institution, and a list of names authorized to use the account.

4. A network system for coordinating the management of credit between an Internet user and a plurality of lending institutions via the Internet, comprising:
a database for storing and receiving account information;
means for receiving account information on at least one credit account from the plurality of lending institutions or the Internet user;
means for storing the account information in a database;
means for receiving selection criteria from the Internet user specifying conditions under which each of the at least one credit account is authorized to be used;
means for receiving from a merchant a request for authorization of a transaction;
means for processing the request including selecting one of the at least one credit account to be used for the transaction;
means for transmitting the account information corresponding to the selected account to the lending institution associated with the selected account;
means for receiving an authorization status from the lending institution;
means for selecting a different account to request authorization from the lending institution associated with the selected account if the authorization status is a denial; and
means for transmitting the authorization status to the merchant.

5. The network system according to claim 4, further comprising:
means for transmitting the account information corresponding to the selected account to a credit card management gateway, wherein the gateway routes the authorization request to the lending institution associated with the selected account; and
wherein the credit card management gateway receives the authorization status from the lending institution and transmits the authorization status to the database.

6. The network system according to claim 5, wherein the transmitting means comprises the Internet.

7. The network system according to claim 4, further comprising security means.

8. The network system according to claim 7, wherein the security means comprises a user-defined PIN code that is entered prior to a merchant swiping a card to initiate a transaction.

9. The network system according to claim 8, wherein the card includes at least one magstripe.

10. The network system according to claim 9, wherein the at least one magstripe corresponds to the database.

11. The network system according to claim 9, wherein the at least one magstripe corresponds to the selected account.

12. The network system according to claim 8, wherein the at least one magstripe corresponds to a telephone minutes account.

13. The network system of claim 4, wherein a primary user assigns a PIN number to at least one secondary user.

14. The network system according to claim 13, wherein the at least one secondary user is a child.

15. The network system according to claim 13, wherein the primary user assigns an account limit to the secondary user.

16. A network system for coordinating the management of credit between an Internet user and a plurality of lending institutions via the Internet, comprising:
a database for storing and receiving account information;
a magstripe writing device configured to write data to a magstripe on a card corresponding to a particular account;
means for receiving account information on at least one credit account from the plurality of lending institutions or the Internet user;
means for storing the account information in a database; and
means for receiving selection criteria from the Internet user specifying which credit account information is to be written by the magstripe writing device on the card.

17. The network system according to claim 16, wherein the magstripe writing device erases the magstripe on the card and rewrites a new barcode on the card corresponding to a different credit account.

18. The network system according to claim 16, wherein the magstripe writing device communicates with the database.

19. The network system according to claim 18, wherein the account information is stored on a removable storage device.

20. The network system according to claim 17, wherein the magstripe writing device is integrated into a personal computer.
